(19) United States
(12) Patent Application Publication
(10) Pub. No.: US 2010/0163400 A1
(43) Pub. Date: Jul. 1, 2010

(54) METHOD OF DISTILLATION AND/OR A DISTILLATION COLUMN

(76) Inventors: William Brian Earl, Christchurch (NZ); Praveen Kumar Bhagat, Auckland (NZ)

Correspondence Address: KEVIN J. MCNEELY, ESQ., 5335 WISCONSON AVENUE, NW, SUITE 440, WASHINGTON, DC, 20015, US

(21) Appl. No.: 12/669,488

(22) PCT Filed: Jul. 16, 2008
(86) PCT No.: PCT/NZ08/00175

§ 371 Date: Jan. 16, 2010

(30) Foreign Application Priority Data
Jul. 16, 2007 (NZ) 556565

(51) Int. Cl. B01D 3/14; B01D 3/32

(52) U.S. Cl. 203/29; 203/39; 202/158

(57) ABSTRACT

The invention comprises a method of reactive-distillation which includes the step of distillation of the surplus light components and separation of the heavy phase components in the same vessel. This may be achieved by utilising a reactive-distillation column having a plurality of trays. A weir is provided on at least most trays and at least most weirs have sufficient height to enable a residence time of material on the tray at least double the residence time of a conventional tray in normal distillation.

### TECHNICAL FIELD

This invention relates to improvements in a method to transesterify, intereserify and esterify fats and oils containing triglycerides and free fatty acids by reactive-distillation and/or a reactive-distillation column.

### BACKGROUND ART

The production of bio-diesel by transesterifying vegetable oils, fish oils and animal fats (such as tallow) is known to be carried out by mainly batch or semi-batch processes. In these processes the reaction times are in the order of 20 minutes to 90 minutes. A common feature of the existing processes are that processing is carried out sequentially, in separate process steps, carried out in separate process vessels (reactors, distillation columns and separation vessels).

In order to satisfactorily manufacture bio-diesel especially from animal fats (tallow) the free fatty acids (hereinafter FFA) need to be at a very low level, for example, about 1 to 2% by weight. When the free fatty in the animal fat exceeds the above values the pre-treatment of tallow is required. This adds to process complexity and costs. A process that can accept higher FFA feedstock is desirable and has definite economic benefits.

### OBJECT OF THE INVENTION

It is therefore an object of the present invention to provide a method of reactive-distillation and/or a reactive-distillation column which will at least improve methods by which bio-diesel or the like can be manufactured continuously from triglyceride feedstocks in a simple yet effective manner or which will at least provide the public with a useful choice.

### STATEMENT OF THE INVENTION

Accordingly in a first aspect the invention consists in a method of distillation including the step of distillation of the surplus light components and separation of the heavy phase components in the same vessel.

Preferably the step of distillation comprises the step of reactive-distillation.

In a further aspect the invention consists in a reactive-distillation column having a plurality of trays, there being a weir on at least most trays and at least most weirs having sufficient height to enable a residence time of material on the tray at least double the residence time of a conventional tray in normal distillation.

Preferably each tray has a weir and each weir is of sufficient height to enable a residence time of material on the tray at least double the residence time of a conventional tray in normal distillation.

Preferably the residence time is up to treble the residence time of a conventional tray.

Preferably the weir is up 60 mm in height.

Preferably the weir is between 20 mm and 60 mm in height.

Preferably the weir is substantially 30 mm in height.

Preferably the ratio of height of weir to diameter of column is up to 6:50.

Preferably the ratio of height of weir to diameter of column is between substantially 2:50 and substantially 6:50.

Preferably the ratio of height to diameter in the weir is substantially 3:50.

In a still further aspect the invention consists in a reactive-distillation column for use in a process of manufacturing bio-diesel from animal fats or any triglyceride feedstock having a plurality of trays with each weir on the tray having sufficient height to enable a residence time of material on the tray at least double the residence time of a conventional tray.

Preferably the residence time is up to treble the residence time of a conventional tray.

Preferably the weir is up 60 mm in height.

Preferably the weir is between 20 mm and 60 mm in height.

Preferably the weir is substantially 30 mm in height.

Preferably the ratio of height to diameter of the weir is up to 6:50.

Preferably the ratio of height to diameter in the weir is between substantially 2:50, and substantially 6:50.

Preferably the ratio of height to diameter in the weir is substantially 3:50.

Preferably the ratio of height to diameter of the weir is empirically determined.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

One preferred form of the invention will now be described with reference to the accompanying drawing in which,

FIG. 1 comprising FIGS. 1a and 1b is a diagrammatic representation of plant to enable the method of reactive-distillation according to the preferred form of the invention to be performed and showing a preferred form of reactive-distillation I column according to the invention,

FIG. 2 is a plan view of part of a tray forming part of a reactive-distillation column according to the invention, and

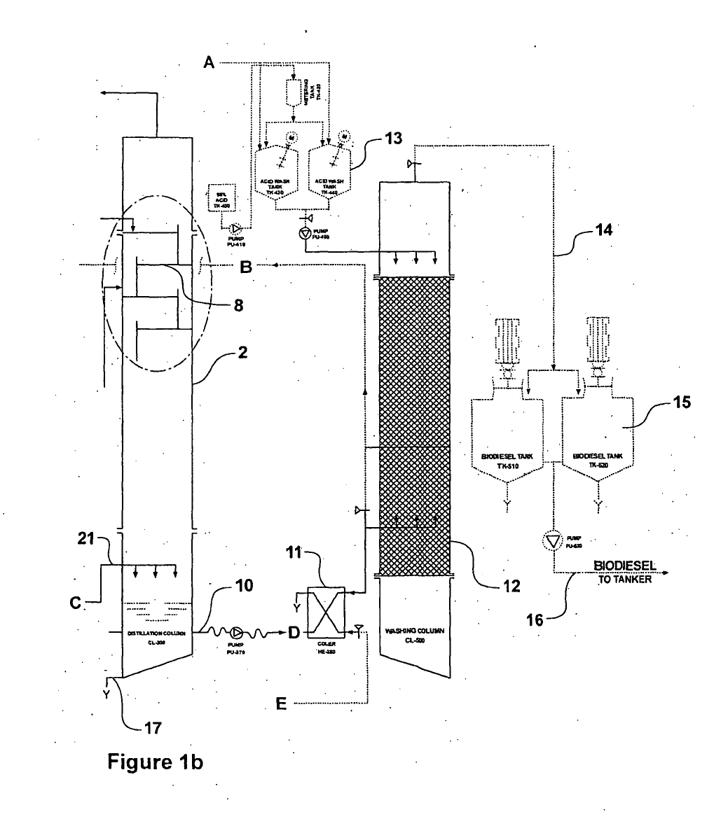

FIG. 3 is a plan view of an enlargement of FIG. 2.

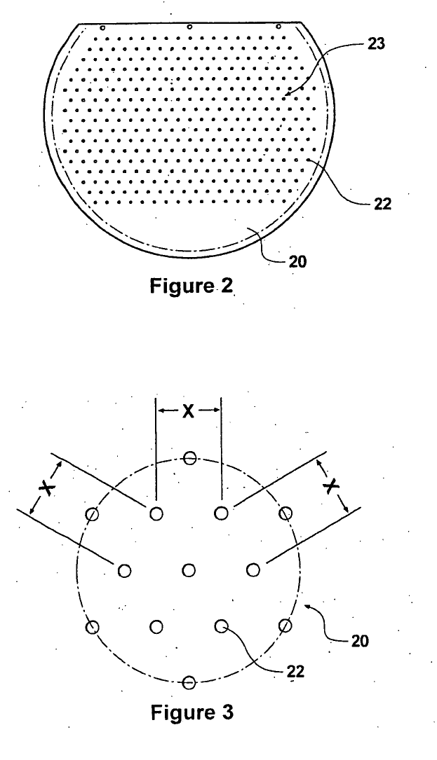

The present invention can handle feedstocks with up to 4% FFA. Where the FFA increases above this level, for example to 55%, methyl esters can be produced by esterifying the feedstock with methanol in the presence of an acidic catalyst first and then reacting the remaining triglycerides by the use of a base catalyst and methanol.

The novelty of the above process is that the reaction times known in prior art for the first reaction using the acid catalyst is long (hours or days). In the present invention the reaction time is in the order of minutes and not significantly different from the base catalyst triglyceride conversion process.

### BEST MODE FOR CARRYING OUT THE INVENTION

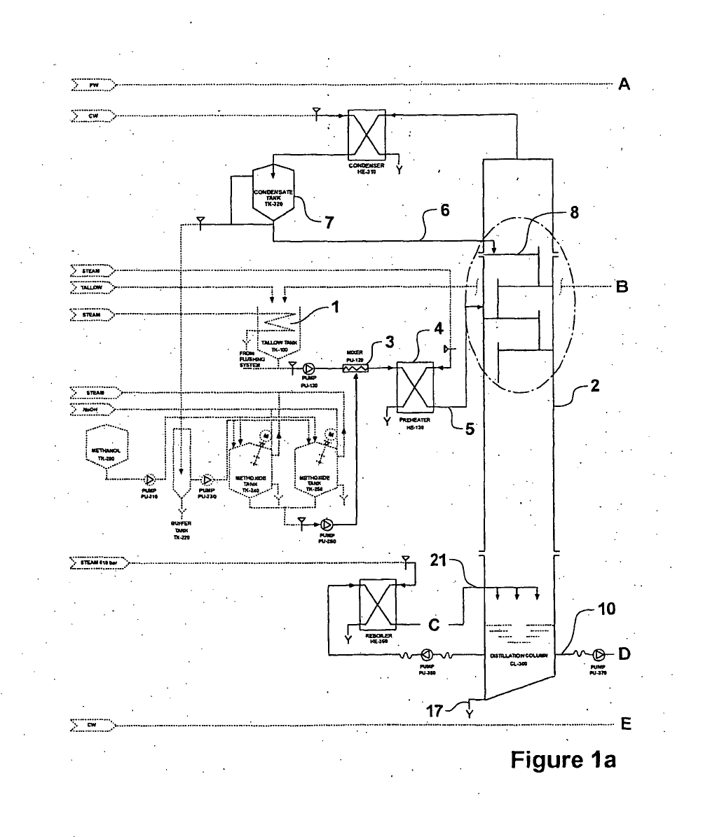

Referring to FIG. 1, triglyceride feedstock is collected in tank 1. The triglyceride feedstock may be any oil or fat from vegetable, fish or animal, suitable for the manufacture of bio-diesel. A reactive-distillation column 2 is provided with material from the tank 1 having gone through a mixer, where it is mixed with methoxide. The mixture may be preheated at 4 before passing along conduit 5 to a reactive-distillation column 2. Reactive-distillation column 2 also receives condensed methanol through line 6 from condensate tank 7.

Within the reactive-distillation column 2 are a plurality of trays such as tray 8. A plurality of such trays are provided and in the preferred form of the invention there about ten such trays of which three may be categorised as wash trays and seven as reactor trays.

A weir is constructed at the outlet of at least most trays and preferably each tray so as to provide a residence time on the tray substantially greater than that, in conventional or known distillation towers. Desirably the residence time of material on the tray is at least double and preferably up to treble the residence time that would be expected from a conventional or known tray. A typical residence time for a conventional tray is about 1 to about 4 minutes depending, for example, on tray size. Thus the construction of this invention may utilise residence times of about 3 to about 12 minutes. Thus the weirs are desirably up to 60 mm in height more preferably substantially 20 mm to substantially 60 mm in height and even more preferably around 30mm in height. When considering the weirs, the ratio of height of weir to diameter of column is desirably up to 6:50 more desirably between 2:50 and 6:50 and most desirably about 3:50. There will be some variation in these ratios as the diameter varies and typically column diameters could be expected to be of the order of half a metre to five metres. The particular aim is to develop a construction having the desired residence times.

The material having spent time on each tray is taken off through line 10 and may pass through a cooler 11 before entering a wash tower 12 where acid wash from tanks 13 washes the bid-diesel. The washed bio-diesel passes through line 14 to collection tanks 15 before being dispensed through line 16.

The reactive-distillation column 2 has acted both as a separator of the light phase by distillation and a separator of the heavy phase by decanting, the heavy phase being drawn off through outlet 17. Effectively the reaction and distillation and decanting processes are performed within the same vessel.

The trays in the reactive-distillation column 2, such as tray 8, are preferably perforated to allow vapour, such as methanol vapour, introduced to the column 2 at inlet 21 to pass upward through the trays. The perforated section of each tray should have a perforated area preferably between and 2% and 8% of the column cross sectional area, more specifically between 3% and 5% of the column cross sectional area. The holes themselves may be about 2 mm to about 8 mm in diameter, preferably 3 mm to 5 mm.

Thus it can be seen that a method of reactive-distillation and/or a reactive-distillation column are provided which has the advantage of distillation of the light phase, transesterification of the reactive triglycerides and separation of the heavy phase can be effected in the same vessel, leading to cost advantages. An additional benefit is that due to the short residence times in the reactor (2 to 10 minutes) and the ability to carry out the overall reaction as a combination of reactions on each of the plates, with an excess of methanol, some of which is carrying the catalyst, sodium or potassium methoxide, the reactions proceed to completion rapidly. This results in the formation of bio-diesel with less unreacted triglycerides and compounds such as soaps and scums. This is enabled in particular by the significant number of trays in the distillation chamber and the provision of the height of the weir such that the residence time of material on each tray is at least double and preferably up to three times the residence time in a conventional known distillation column.

It will be apparent to the skilled person that other distillation columns such as valve trays, and bubble cap trays could be used in a manner that achieves the result. Other methods such as a packed bed could also be used to increase the time equivalent to the time on the trays in the reactive distillation column.

Throughout the description and claims of this specification the word “comprise” and variations of that word, such as “comprises” and “comprising”, are not intended to exclude other additives, components, integers or steps.

What we claim is:

1. A method of distillation in a vessel, method comprising:
distilling surplus light components; and
separating heavy phase components in the same vessel.

2. The method as claimed in claim 1, wherein distilling comprises reactive-distillation.

3. A reactive-distillation column, comprising:
a plurality of trays, there being a weir on at least most trays and at least most weirs having sufficient height to enable a residence time of material on the tray at least double the residence time of a conventional tray in normal distillation.

4. The reactive-distillation column as claimed in claim 2 wherein each tray has a weir and each weir is of sufficient height to enable a residence time of material on the tray at least double the residence time of a conventional tray in normal distillation.

5. The reactive-distillation column as claimed in of claim 3 wherein the residence time is up to treble the residence time of a conventional tray.

6. The reactive-distillation column as claimed in claim 3 wherein the weir is up 60 mm in height.

7. The reactive-distillation column as claimed in claim 6 wherein the weir is between 20 mm and 60 mm in height.

8. The reactive-distillation column as claimed in claim 7 wherein the weir is substantially 30 mm in height.

9. The reactive-distillation column as claimed in claim 3 wherein the ratio of height of weir to diameter of column is up to 6:50.

10. The reactive-distillation column as claimed in claim 9 wherein the ratio of height of weir to diameter of column is between 2:50 and 6:50.

11. The reactive-distillation column as claimed in claim 10 wherein the ratio of height to diameter in the weir is 3:50.

12. A reactive-distillation column for use in a process of manufacturing bio-diesel from animal fats or any triglyceride feedstock, comprising:
a plurality of trays with each having a weir on the tray having sufficient height to enable a residence time of material on the tray at least double the residence time of a conventional tray.

13. The reactive-distillation column as claimed in claim 12 wherein the residence time is up to treble the residence time of a conventional tray.

14. The reactive-distillation column as claimed in claim 12 wherein the weir is up 60 mm in height.

15. The reactive-distillation column as claimed in claim 14 wherein the weir is between 20 mm and 60 mm in height.

16. The reactive-distillation column as claimed in claim 15 wherein the weir is substantially 30 mm in height.

17. The reactive-distillation column as claimed in claim 12 wherein the ratio of height to diameter of the weir is up to 6:50.

18. The reactive-distillation column as claimed in claim 17 wherein the ratio of height to diameter in the weir is between 2:50 and 6:50.

19. The reactive-distillation column as claimed in claim 18 wherein the ratio of height to diameter in the weir is substantially 3:50.

20. The reactive-distillation column as claimed in claim 12 wherein the ratio of height to diameter of the weir is empirically determined.
